(19) United States
(12) Patent Application Publication
(10) Pub. No.: US 2019/0207278 A1
(43) Pub. Date: Jul. 4, 2019

(54) COOLING MEMBER AND POWER STORAGE MODULE INCLUDING COOLING MEMBER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hideyuki KUBOKI, Mie (JP); Hiroki HIRAI, Mie (JP); Makoto HIGASHIKOZONO, Mie (JP); Akihisa HOSOE, Osaka-shi (JP); Yoshiyuki HIROSE, Osaka-shi (JP); Akihiro NAGAFUCHI, Osaka-shi (JP); Tomoharu TAKEYAMA, Osaka-shi (JP); Eiichi KOBAYASHI, Osaka-shi (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/323,688

(22) PCT Filed: Jul. 31, 2017
(86) PCT No.: PCT/JP2017/027606

§ 371 Date: Feb. 6, 2019

(30) Foreign Application Priority Data
Aug. 16, 2016 (JP) 2016-159722

(51) Int. Cl. H01M 10/6552; H01M 10/6554; H01M 10/625; H01M 10/613

(52) U.S. Cl. CPC H01M 10/6552; H01M 10/613; H01M 10/625; H01M 10/6554

(57) ABSTRACT

A cooling member includes: a coolant; a sealing body in which a first sheet portion and a second sheet portion are opposed to each other and the coolant is hermetically sealed; absorption members that are disposed in the sealing body to absorb the coolant; and spacers that are disposed inside the sealing body to maintain a space between the first sheet portion and the second sheet portion.

### TECHNICAL FIELD

The present description discloses a technique for cooling by a cooling member.

### BACKGROUND ART

There has been conventionally known a technique for cooling a power storage element. Patent Document 1 describes that a battery module is stored in a pack case and positive terminals and negative terminals of a plurality of cells are electrically connected together via bus bars. When a coolant charged in the lower portion of the pack case becomes evaporated and condensed in the upper portion of the pack case, the battery is cooled.

### RELATED ART DOCUMENT

### Patent Document

Patent Document 1: Japanese Unexamined Patent Application Publication No. 2010-211963

### DISCLOSURE OF THE PRESENT INVENTION

### Problem to be Solved by the Invention

According to the technique described in Patent Document 1, the coolant is to be evaporated and condensed in the pack case, and thus the entire pack case needs to be hermetically sealed. This causes a problem that it is not easy to simplify the configuration for cooling.

The technique disclosed herein is completed under the foregoing circumstances, and an object of the technique is to simplify the configuration for cooling.

### Means for Solving the Problem

A cooling member described herein includes: a coolant; a sealing body in which a first sheet portion and a second sheet portion are opposed to each other and the coolant is hermetically sealed; an absorption member that is disposed in the sealing body to absorb the coolant; and a spacer that is disposed inside the sealing body to maintain a space between the first sheet portion and the second sheet portion.

According to the foregoing configuration, it is possible to dissipate heat of a heat generator via the cooling member in which the coolant is hermetically sealed in the sealing body. Therefore, as compared to the configuration in which the coolant is charged in a case where a power storage element as a heat generator is stored, for example, the case does not necessarily need to be hermetically sealed. This makes it possible to simplify for cooling.

In the configuration in which the absorption member to absorb the coolant is disposed in the sealing body of the cooling member, when the sealing body receives pressure or the like from another member, the absorption member becomes crushed and does not form a path of the coolant for facilitating the movement of the coolant, and there is a fear of a decrease in cooling performance.

According to the present configuration, the spacer to maintain the space between the first sheet portion and the second sheet portion is disposed inside the sealing body, and thus even if the sealing body receives pressure or the like from another member, the spacer maintains the space between the first sheet portion and the second sheet portion to make the internal absorption member less likely to be crushed. Accordingly, it is possible to suppress a decrease in cooling performance caused by the crushing of the absorption member to absorb the coolant.

Embodiments of the technique described herein are preferably as described below.

The spacer may be disposed in the sealing body on a boundary portion side between the first sheet portion and the second sheet portion.

This makes it possible to suppress the crushing of the absorption member at the boundary portion side between the first sheet portion and the second sheet portion where the absorption member is likely to be crushed.

The spacer may extend from one side edge portion to another side edge portion opposite to the one side edge portion of the sealing body.

This makes it possible to move the coolant along the direction of extension of the spacer.

A height of the spacer may be larger than a thickness of the absorption member.

This generates a gap between the sealing body and the absorption member to further suppress the crushing of the absorption member.

A power storage module may include the cooling member, and a power storage element stacked on the cooling member.

The power storage module may further include a heat transfer plate that is stacked on the power storage element with the cooling member sandwiched between the heat transfer plate and the power storage element.

This makes it possible to dissipate the heat of the power storage element to the outside via the heat transfer plate.

### Advantageous Effect of the Invention

According to the technique described herein, it is possible to simplify the configuration for cooling.

### BRIEF DESCRIPTION OF THE DRAWINGS

FIG. 1 is a plane view of a power storage module in a first embodiment.

FIG. 2 is a front view of the power storage module.

FIG. 3 is a cross-sectional view of FIG. 1 taken along line A-A.

FIG. 4 is a planar view of a cooling member.

FIG. 5 is a side view of the cooling member.

FIG. 6 is a cross-sectional view of FIG. 4 taken along line B-B.

FIG. 7 is a partially enlarged view of FIG. 6.

FIG. 8 is a cross-sectional view of FIG. 5 taken along line C-C.

FIG. 9 is a cross-sectional view of a cooling member in a second embodiment.

### MODES FOR CARRYING OUT THE INVENTION

### First Embodiment

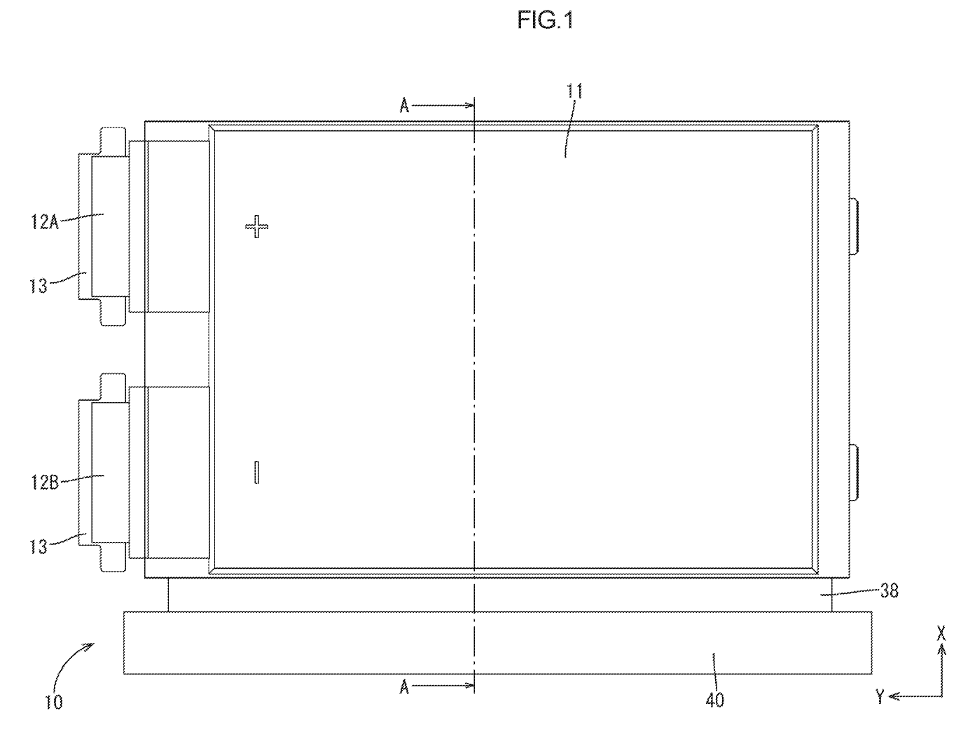

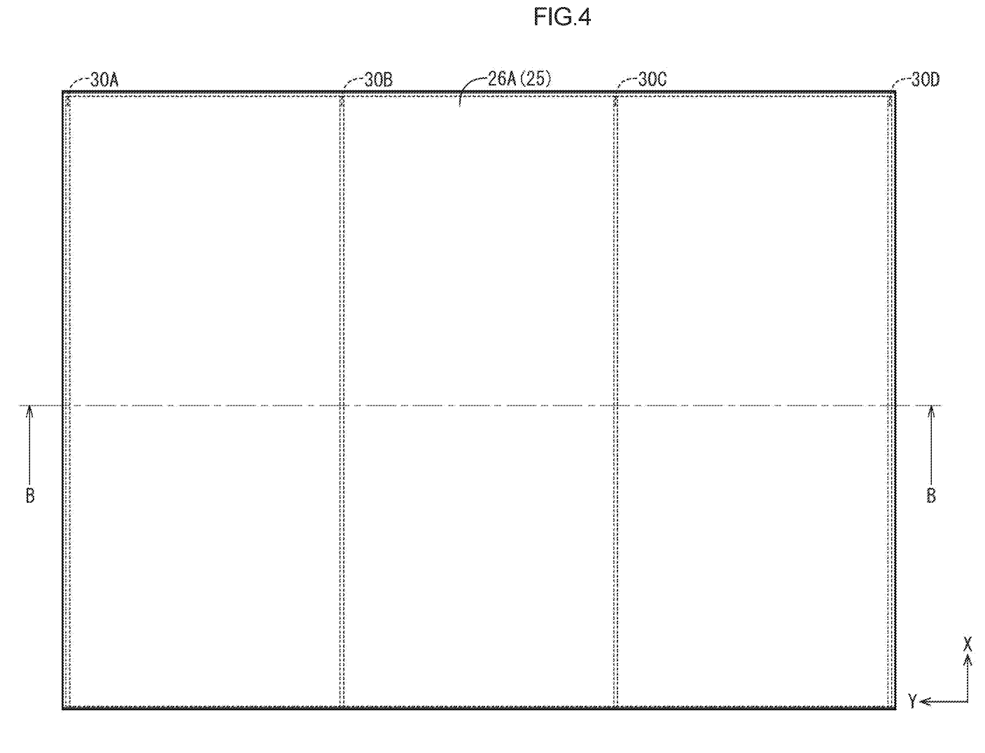

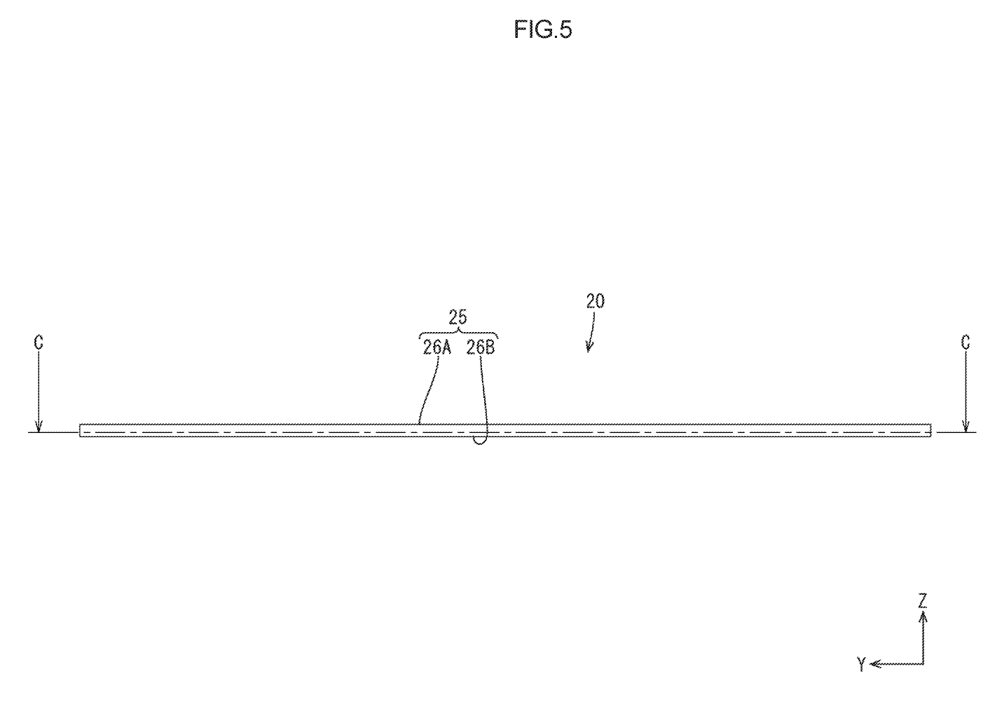

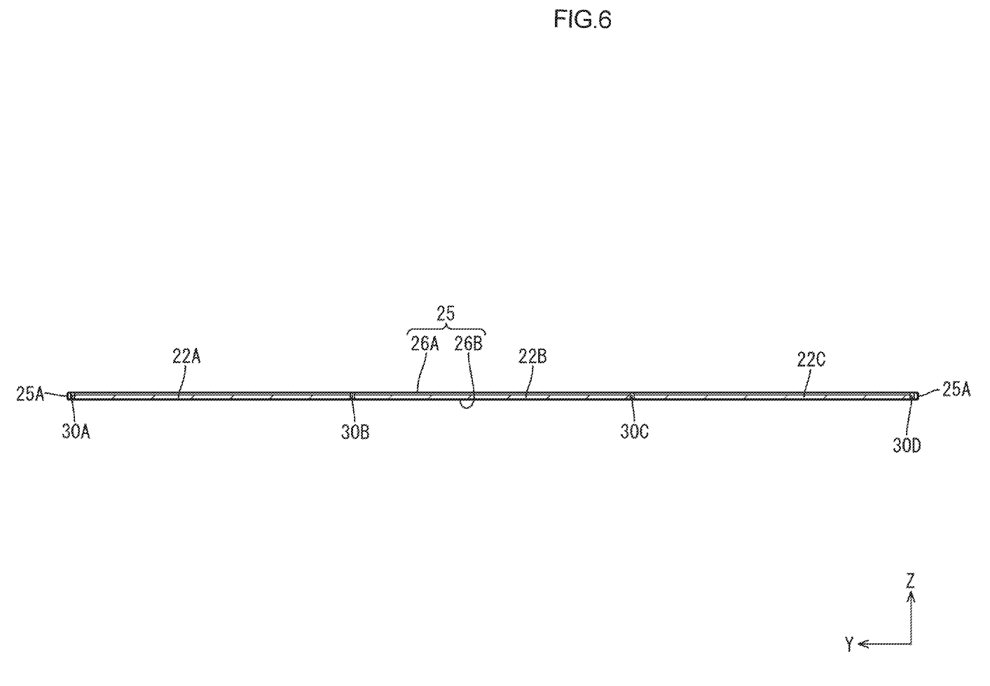

A first embodiment will be described with reference to FIGS. 1 to 8. A power storage module 10 in the present embodiment is mounted in a vehicle such as an electric car or hybrid car, for example, to supply electric power to a load such as a motor. Although the power storage module 10 can be disposed in any orientation, the following descriptions are based on the assumption that an X direction is a leftward direction, a Y direction is a forward direction, and a Z direction is an upward direction.

(Power Storage Module 10)

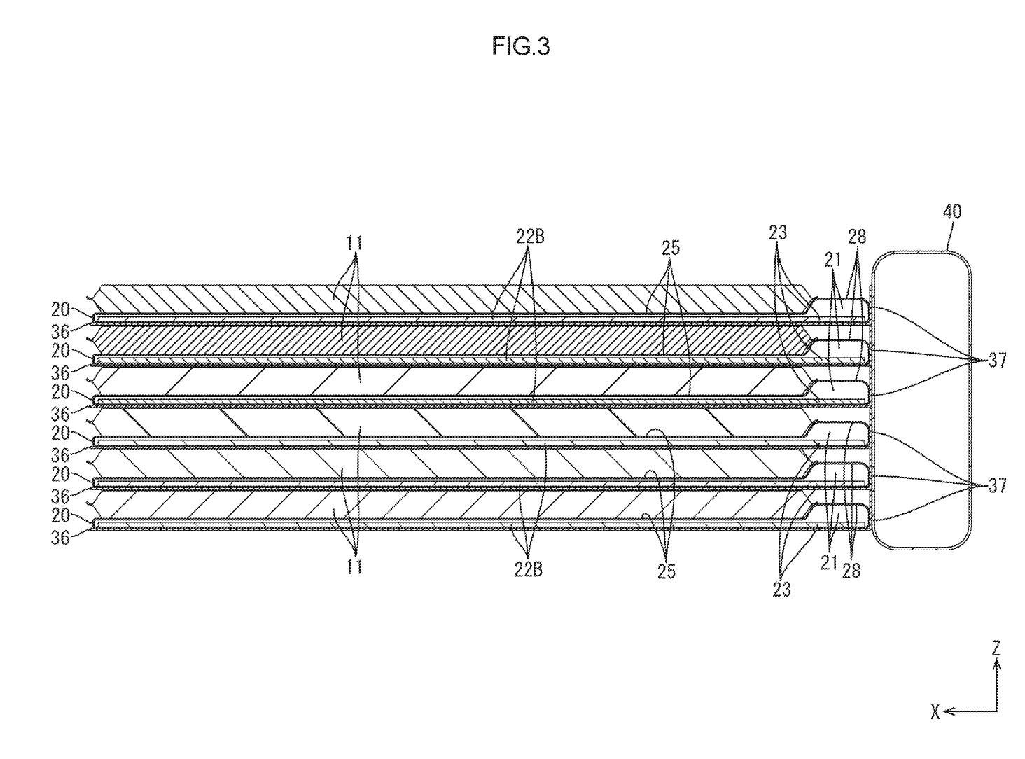

As illustrated in FIG. 3, the power storage module 10 includes: a plurality of (six in the present embodiment) power storage elements 11; a plurality of (six in the present embodiment) cooling members 20 that are stacked on the power storage elements 11 to cool the power storage elements 11; and a plurality of (six in the present embodiment) heat transfer plates 36 that are stacked between the cooling members 20 and the power storage elements 11 to transmit heat of the cooling members 20 and the power storage elements 11.

(Power Storage Elements 11)

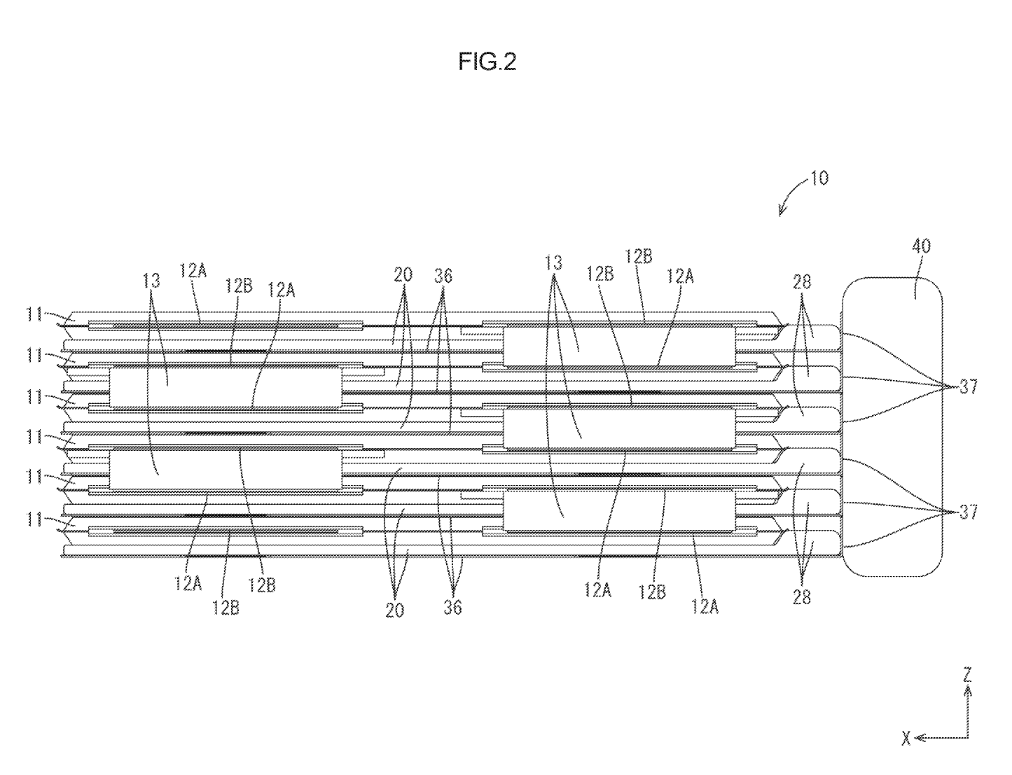

Each of the power storage elements 11 is formed by sandwiching a power storage factor not illustrated between a pair of battery laminate sheets and bonding side edges of the battery laminate sheets in a liquid-tight manner by a publicly known method such as heat welding. A positive electrode terminal 12A and a negative electrode terminal 12B in metallic foil form protrude from the front end edge of each of the power storage elements 11, from inside to outside of the battery laminate sheets in a liquid-tight state against the inner surface of the battery laminate sheet as illustrated in FIG. 2. The electrode terminal 12A and the electrode terminal 12B of each of the power storage elements 11 are disposed with a space therebetween and are electrically connected to the internal power storage factor.

The plurality of power storage elements 11 are vertically aligned and the adjacent power storage elements 11 are disposed such that one electrode terminal 12A is positioned next to the other electrode terminal 12B. The adjacent electrode terminal 12A and electrode terminal 12B are electrically connected together via a plurality of (five in present embodiment) U-shaped connection members 13. The electrode terminals 12A, 12B and the connection members 13 are connected together by a publicly known method such as laser welding, ultrasonic welding, or brazing, for example. The adjacent electrode terminals 12A and 12B are connected by the connection members 13, so that the plurality of power storage elements 11 are connected in series.

In the present embodiment, examples of the power storage elements 11 include secondary batteries such as lithium-ion secondary batteries or nickel-metal-hydride secondary batteries, capacitors such as electric double-layer capacitors or lithium ion capacitors, and any type can be selected as necessary.

(Cooling Members 20)

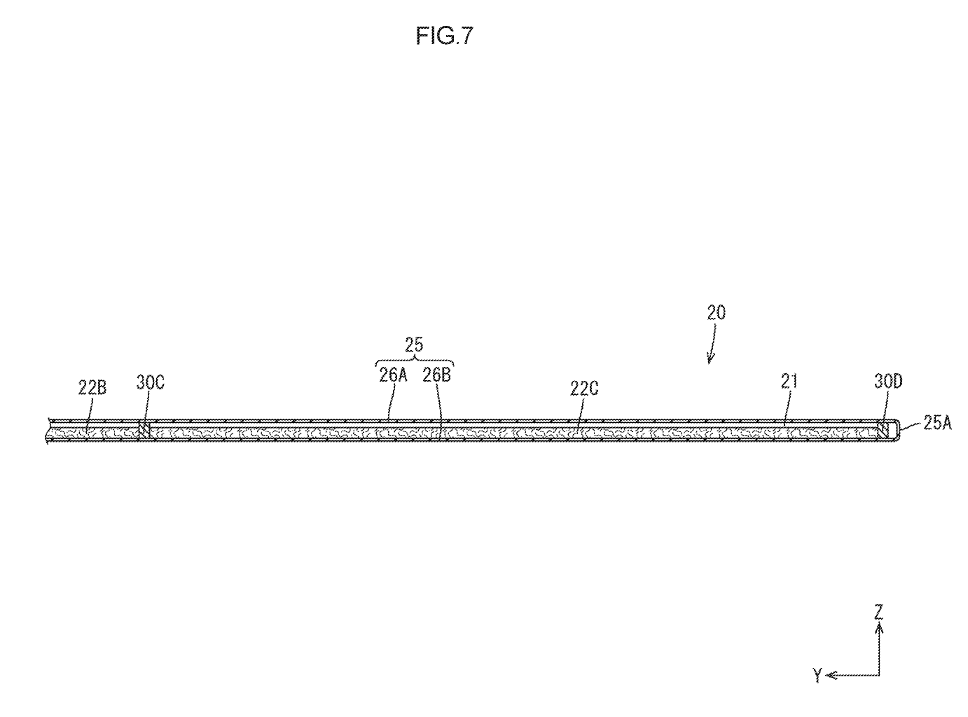

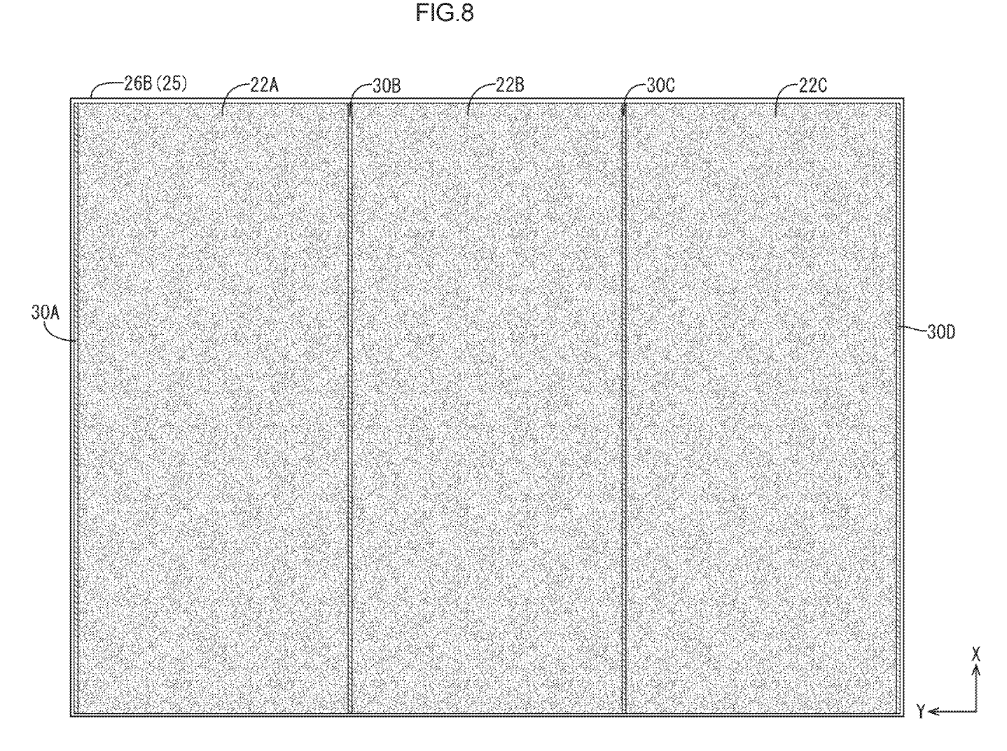

As illustrated in FIGS. 7 and 8, the cooling member 20 includes: a coolant 21 that varies between liquid and gaseous states; a plurality of (three in the present embodiment) absorption members 22A to 22C that absorb the coolant 21; a sealing body 25 that hermetically seals the coolant 21 and the absorption members 22A to 22C; and a plurality of (four in the present embodiment) spacers 30A to 30D that maintain the spaces in the sealing body 25. The coolant 21 can be one or more selected from a group consisting of perfluorocarbon, hydrofluoroether, hydrofluoroketone, fluorine inert liquid, water, and alcohols such as methanol and ethanol, for example. The coolant 21 may have insulating properties or conductive properties. The amount of the coolant 21 sealed in the sealing body 25 can be selected as necessary.

(Absorption Members 22A to 22C)

Each of the absorption members 22A to 22C has a substantially rectangular sheet-shape and is formed from a material configured to absorb the coolant 21. The absorption members 22A to 22C may be formed by processing a material configured to absorb the coolant 21 in fiber form and weaving into a fabric or may be formed from a non-woven fabric. The form of the non-woven fabric may be fiber sheet, web (thin film sheet made of fiber only), or bat (blanket-like fiber). The material for the absorption members 22A to 22C may be natural fiber, synthetic fiber formed from synthetic resin, or a combination of natural fiber and synthetic fiber.

The absorption members 22A to 22C are disposed in a wide region as compared to the region overlapping the power storage elements 11, and thus each of the absorption members 22A to 22C in the sealing body 25 includes an absorption extension portion 23 (see FIG. 3) that is extended from the region overlapping the power storage elements 11 to a region not overlapping the power storage elements 11.

(Sealing Body 25)

The sealing body 25 can be formed by stacking and joining (bonding) together substantially rectangular first sheet portion 26A and second sheet portion 26B in a liquid-tight manner by a publicly known method such as adhesion, welding, or deposition, for example, as illustrated in FIG. 7. Each of the first sheet portion 26A and the second sheet portion 26B is formed by laminating a synthetic resin film to the both sides of a metallic sheet. The metal constituting the metallic sheet can be any metal selected from among aluminum, aluminum alloy, copper, and copper alloy as necessary. The synthetic resin constituting a synthetic resin film can be any synthetic resin selected from among polyolefins such as polyethylene and polypropylene, polyesters such as polybutylene terephthalate and polyethylene terephthalate, polyamides such as nylon 6 and nylon 6, 6 as necessary. The sealing body 25 according to the present embodiment is formed by stacking and thermally fusing the surfaces of the first sheet portion 26A and the second sheet portion 26B with synthetic resin films stacked.

The sealing body 25 has the first sheet portion 26A that covers the upper side of the absorption members 22A to 22C and the second sheet portion 26B that covers the lower side of the absorption members 22A to 22C. The sealing body 25 has a peripheral edge portion where the first sheet portion 26A and the second sheet portion 26B are connected, as a boundary portion 25A. The upper surface of the first sheet portion 26A is in contact with the lower surface of the power storage element 11, and the lower surface of the second sheet portion 26B is in contact with the upper surface of the heat transfer plate 36. A portion of the first sheet portion 26A extended in a region not overlapping the power storage element 11 and covering the absorption extension portions 23 of the absorption members 22A to 22C is set as a bulging portion 28 that is configured to bulge and deform by evaporation of the coolant 21 in the sealing body 25 as illustrated in FIG. 3.

The bulging portion 28 is formed when the sealing body 25 becomes deformed and bulged with a rise in the inner pressure of the sealing body 25 caused by evaporation of the coolant 21 in the sealing body 25. The portion of the sealing body 25 other than the bulging portion 28 does not bulge or deform even with a rise in the inner pressure caused by evaporation of the coolant 21 in the sealing body 25 because the portion is in contact with the power storage element 11 and the heat transfer plate 36 and is restricted in bulging.

(Spacers 30A to 30D)

As illustrated in FIGS. 7 and 8, spacers 30A to 30D are members elongated in the horizontal direction and are disposed with a space therebetween as seen in the front-back direction. The spacers 30A to 30D are formed at a constant height along the entire width in the horizontal direction. The spacers 30A and 30D on both sides are disposed on the boundary portion 25A side between the first sheet portion 26A and the second sheet portion 26B (on the inner edge portion side of the sealing body 25). Each of the spacers 30A to 30D is formed from a member made of a synthetic resin, a metal, or the like, for example, and has a degree of strength with which the spacers 30A to 30D are less likely to be plastically deformed due to external force acting on at least the sealing body 25 (for example, the bulging of the power storage elements 11). The synthetic resin can be a hard resin but is not limited to this but an elastically deformable member such as rubber may be used, for example.

(Heat Transfer Plates 36)

Each of the heat transfer plates 36 is rectangular in shape and stacked on the power storage element 11 with the cooling member 20 sandwiched between the heat transfer plate 36 and the power storage element 11 as illustrated in FIG. 3, and is formed from a member with high heat conductivity such as aluminum, aluminum alloy, copper, or copper alloy. The heat transfer plate 36 forms a flat-plate shape that is stacked on a region of the power storage element 11 and is in contact with the power storage element 11 and the second sheet portion 26B. The heat transfer plate 36 receives the heat of the power storage element 11. The heat transfer plate 36 has a partition wall 37 that is bent in an orthogonal direction on the right end side. The outer surface of the partition wall 37 is in surface contact with the left side surface of a heat dissipation member 40. Accordingly, the heat of the power storage elements 11 transfers to the heat transfer plates 36 vertically adjacent to each other with the bulging portions 28 of the cooling members 20 therebetween, and then is dissipated from the heat dissipation member 40 to the outside.

(Heat Dissipation Member 40)

The heat dissipation ember 40 is disposed on a lateral side of the power storage module 10 to dissipate heat having been transferred to the heat transfer plates 36 to the outside. The left side surface (surface on the power storage module 10 side) of the heat dissipation member 40 closely adheres to the outer surfaces of the partition walls 37 of the heat transfer plates 36. The heat dissipation member 40 is formed from a metal such as aluminum or aluminum alloy and has an inlet opening and an outlet opening for a cooling material not illustrated. A cooling liquid as a cooling material is introduced into the lower inlet opening and discharged from the upper outlet opening. The cooling liquid circulates through a heat dissipation path not illustrated to dissipate heat having been transferred to the cooling liquid to the outside. The heat dissipation member 40 may have a pipe (not illustrated) entirely extending inside with a plurality of folds for passage of the cooling liquid. In the present embodiment, the cooling liquid is water. However, the cooling liquid is not limited to this but may be a liquid such as oil. Alternatively, the cooling liquid may be an antifreeze liquid. In addition, the cooling liquid is not limited to a liquid but may be a gas.

The present embodiment produces the following operations and advantageous effect.

The cooling member 20 includes: the coolant 21; the sealing body 25 in which the first sheet portion 26A and the second sheet portion 26B are opposed to each other and the coolant 21 is hermetically sealed; the absorption members 22A to 22C that are disposed in the sealing body 25 to absorb the coolant 21; and the spacers 30A to 30D that are disposed inside the sealing body 25 to maintain the space between the first sheet portion 26A and the second sheet portion 26B.

According to the present embodiment, it is possible to dissipate heat of the power storage elements 11 as heat generators via the cooling members 20 in which the coolant 21 is hermetically sealed in the sealing body 25. Accordingly, as compared to the configuration in which the coolant 21 is charged in the case where the power storage elements 11 are stored, for example, the case does not necessarily need to be hermetically sealed. This makes it possible to simplify the configuration for cooling the power storage module. In the configuration in which the absorption members 22A to 22C to absorb the coolant 21 are disposed in the sealing body 25 of the cooling member 20 for cooling the power storage elements 11, when the sealing body 25 receives pressure or the like from another member, the absorption members 22A to 22C become crushed and do not form a path of the coolant 21 for facilitating the movement of the coolant 21, and there is a fear of a decrease in cooling performance.

According to the present embodiment, the spacers 30A to 30D to maintain the space between the first sheet portion 26A and the second sheet portion 26B are disposed inside the sealing body 25, and thus even if the sealing body 25 receives pressure or the like from another member, the spacers 30A to 30D maintain the space between the first sheet portion 26A and the second sheet portion 26B to make the internal absorption members 22A to 22C less likely to be crushed. This suppresses a decrease in cooling performance caused by the crushing of the absorption members 22A to 22C to absorb the coolant 21.

The spacers 30A to 30D are disposed on the boundary portion 25A side between the first sheet portion 26A and the second sheet portion 26B.

This suppresses the crushing of the absorption members 22A to 22C on the boundary portion 25A side between the first sheet portion 26A and the second sheet portion 26B where the absorption members 22A to 22C are likely to be crushed.

The spacers 30A to 30D extend from a left side edge portion (one side edge portion) of the sealing body 25 to a right side edge portion (another side edge portion opposite to the one side edge portion) of the sealing body 25.

This makes it possible to move the coolant 21 along the direction of extension of the spacers 30A to 30D.

The height of the spacers 30A to 30D is larger than the thickness of the absorption members 22A to 22C.

This generates a gap between the first sheet portion 26A of the sealing body 25 and the absorption members 22A to 22C to suppress the crushing of the absorption members 22A to 22C in a more reliable manner.

The power storage module 10 includes the heat transfer plates 36 that are stacked on the power storage elements 11 with the cooling members 20 sandwiched between the heat transfer plates 36 and the power storage elements 11.

This makes it possible to dissipate the heat of the power storage elements 11 to the outside via the heat transfer plates 36. In addition, variation in heat of the power storage elements 11 can be evened out by the heat transfer plates 36. Further, fixing the heat transfer plates 36 to a case or the like reduces pressure on the cooling members 20 via the heat transfer plates 36, thereby to further suppress the crushing of the absorption members 22A to 22C.

### Second Embodiment

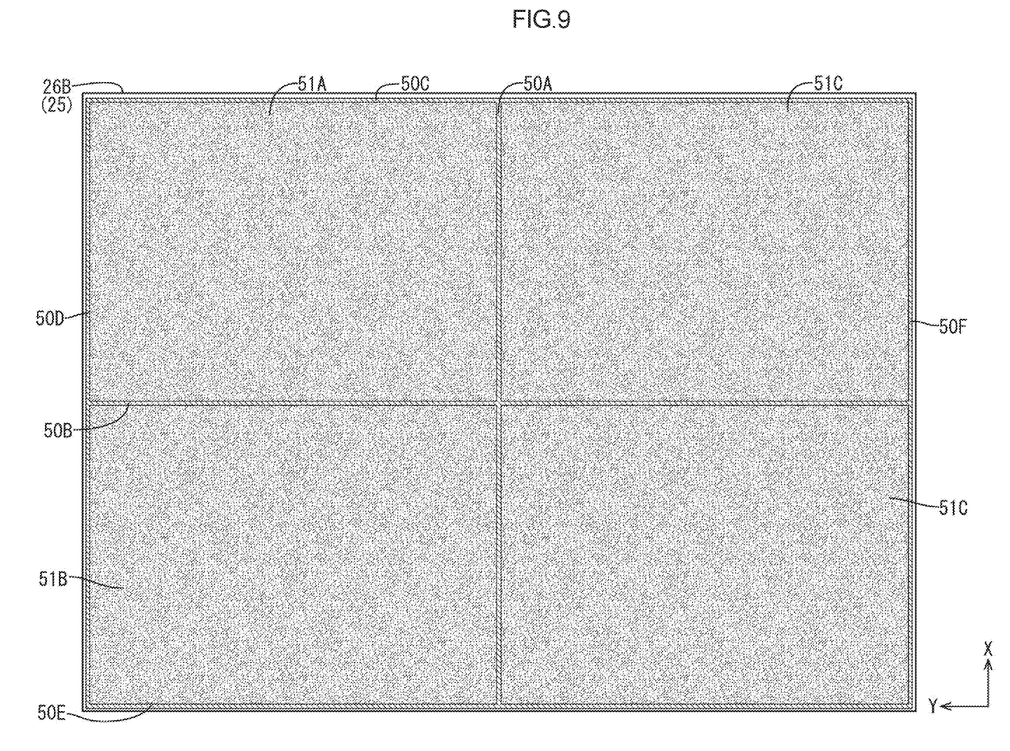

A second embodiment will be described with reference to FIG. 9. In the second embodiment, spacers 50A to 50F are disposed in a lattice pattern in a sealing body 25. In other components, the second embodiment is identical to the first embodiment. Thus, the components identical to those in the first embodiment will be given the reference symbols identical to those in the first embodiment and descriptions thereof will be omitted.

The spacers 50A to 50F are elongated members. The spacer 50A crosses a middle portion of the sealing body 25 as seen in the horizontal direction, and the spacer 50B crosses a middle portion of the sealing body 25 in the front-back direction. The spacers 50C to 50F are disposed on a boundary portion 25A side between a first sheet portion 26A and a second sheet portion 26B (the entire perimeter of the inner peripheral edge portion of the sealing body 25). Rectangular absorption members 51A to 51D are disposed in the regions divided by the spacers 50A to 50F.

### Other Embodiments

The technique described herein is not limited to the embodiments described above and illustrated in the drawings. For example, the following embodiments are included in the scope of the technique described herein:

(1) In the foregoing embodiments, the absorption members 22A to 22C and 51A to 51D are partitioned at the positions of the spacers 30A to 30D and 50A to 50F. However, the absorption members 22A to 22C and 51A to 51D are not limited to this configuration. For example, the absorption members 22A to 22C and 51A to 51D may be integrally formed and the spacers 30A to 30D and 50A to 50F may be disposed such that the absorption members 22A to 22C and 51A to 51D are elastically deformed at the positions of the spacers 30A to 30D and 50A to 50F.

(2) The plurality of spacers 50A to 50F is separated from each other but the spacers 50A to 50F may be integrally formed (for example, as a frame).

(3) The spacers 30A to 30D and 50A to 50F extend from the one side edge portion to the other side edge portion of the sealing body 25 but the spacers 30A to 30D and 50A to 50F are not limited to this. For example, a spacer extending in one direction may be partitioned into a plurality of portions. In addition, for example, a plurality of circular column-shaped or angular column-shaped spacers may be discretely disposed.

(4) The cooling members 20 are to cool the power storage elements 11 as heat generators. However, the cooling members 20 may be cooling members for cooling heat generators other than the power storage elements 11.

(5) The numbers of the power storage elements 11, the cooling members 20, and the heat transfer plates 36 are not limited to the numbers in the foregoing embodiments but can be changed as appropriate.

(6) The sealing body 25 is configured such that the separate first sheet portion 26A and second sheet portion 26B are bonded together. However, the sealing body 25 is not limited to this configuration. For example, one sheet member may be folded back to form a first sheet portion and a second sheet portion.

(7) The power storage module 10 may not include the heat dissipation member 40. For example, the power storage module 10 may be covered with a metallic or synthetic resin case not illustrated, so that the heat of the power storage module 10 is dissipated via the case to the outside without the intervention of the heat dissipation member 40. In addition, for example, the case may be a part of the heat dissipation member 40 or the case may cover the entire power storage module 10 including the heat dissipation member 40. In this case, for example, the case may sandwich the power storage module 10 from the upper and lower sides to hold the power storage module 10.

### EXPLANATION OF SYMBOLS

10: Power storage module
11: Power storage element
20: Cooling member
21: Coolant
22A to 22C and 51A to 51D: Absorption member
25: Sealing body
26A: First sheet portion
26B: Second sheet portion
28: Bulging portion
30A to 30D and 50A to 50F: Spacer
36: Heat transfer plate
40: Heat dissipation member

1-6. (canceled)

7. A power storage module comprising:
a power storage element;
a cooling member that is adjacent to the power storage element; and
a heat transfer plate that is disposed so that the cooling member is sandwiched between the heat transfer plate and the power storage element, wherein the cooling member comprises:
a coolant;
a sealing body in which a first sheet portion and a second sheet portion are opposed to each other and the coolant is hermetically sealed;
an absorption member that is disposed in the sealing body to absorb the coolant; and
a spacer that is disposed inside the sealing body to maintain a space between the first sheet portion and the second sheet portion, wherein
the sealing body includes a bulging portion that is extended in a region not overlapping the power storage element, the bulging portion being configured to bulge and deform by evaporation of the coolant.

8. The power storage module according to claim 7, wherein the spacer is disposed in the sealing body on a boundary portion side between the first sheet portion and the second sheet portion.

9. The power storage module according to claim 7, wherein the spacer extends from one side edge portion to another side edge portion opposite to the one side edge portion of the sealing body.

10. The power storage module according to claim 8, wherein the spacer extends from one side edge portion to another side edge portion opposite to the one side edge portion of the sealing body.

11. The power storage module according to claim 7, wherein a height of e spacer is larger than a thickness of the absorption member.

12. The power storage module according to claim 8, wherein a height of the spacer is larger than a thickness of the absorption member.

13. The power storage module according to claim 9, wherein a height of the spacer is larger than a thickness of the absorption member.

14. The power storage module according to claim 10, wherein a height of the spacer is larger than a thickness of the absorption member.
